(19) United States
(12) Patent Application Publication
(10) Pub. No.: US 2008/0034402 A1
(43) Pub. Date: Feb. 7, 2008

(54) METHODS, SYSTEMS, AND COMPUTER PROGRAM PRODUCTS FOR IMPLEMENTING POLICY-BASED SECURITY CONTROL FUNCTIONS

(75) Inventors: Patrick S. Botz, Rochester, MN (US); Daniel P. Kolz, Rochester, MN (US); Garry J. Sullivan, Rochester, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/462,796

(22) Filed: Aug. 7, 2006

(51) Int. Cl. H04L 9/00

(52) U.S. Cl. 726/1

(57) ABSTRACT

A method, system, and computer program product for implementing policy-based security control functions is provided. The method includes constructing an organizational domain specifying business assets to be secured and the actors in specific roles requiring access to the business assets. The method also includes constructing a control policy domain including system setting attributes and access control policies for a computer system, the access control policies specifying permissions-based access to specified types of data based upon actor and purpose of use criteria. The method further includes mapping user identifiers to corresponding actors and mapping system artifacts in the computer system or subsystem to business assets defined in the organizational domain to which an access control policy is to be applied. The method also includes applying the access control policies to the system.

### TRADEMARK

IBM® is a register trademark of International Business Machines Corporation, Armonk, N.Y. U.S.A. Other names used herein may be registered trademarks, trademarks or product names of International Business Machines Corporation or other companies.

### BACKGROUND OF THE INVENTION

1. Field of the Invention

This invention relates to system security processes, and particularly to methods, systems, and computer program products for implementing policy-based security control functions.

2. Description of Background

Securing any business asset, whether real or electronic, requires an ongoing process of analysis of risks and probability of risks to corporate assets, establishing a suitable security policy to mitigate those risks identified by the analysis and which are determined to require mitigation, implementing the security policy, and verifying the implementation. Risks to corporate data include disclosure to unauthorized individuals, loss, theft, and integrity.

Corporate officers are ultimately and, increasingly, legally responsible to investors for protecting the assets of the business and any personal information they collect and store. As such, corporate officers are ultimately responsible for ensuring that an adequate security policy is defined and accurately implemented.

The role of the system administrator of a computer system is to implement policy, not to define it. Unfortunately, there is currently no easy way to associate the expression of a security policy directly with an implementation of that policy. Because of the lack of tools that obviously tie the expression and management of policy with the actual implementation of that policy, the security process is poorly understood, rarely implemented and when implemented, is done so inefficiently.

Most often, system administrators implicitly define policy by attempting to implement “best practices” or implementing security they deem is “good enough.” This means that the actual policy is rarely explicitly defined, and therefore it becomes impossible to measure whether the business assets are properly protected.

System administrators tend to concentrate on mitigating technical exploits rather than implementing any coherent policy. For example, software bugs that unintentionally enable access by intruders resulting in potential disclosure of sensitive information, inappropriate access to files and database tables that make it possible for unauthorized users to change data, and overly permissive application and operating systems that allow an attacker to overload or crash the system.

System administrators attempt to minimize these risks by, e.g., using the tools and functions provided by an operating system and/or additional security management products. They use these functions to update software on a regular basis (e.g., patches), apply restrictions to various users who do not require access to information in the system, and to establish system settings, e.g., for applications and operating systems) in accordance with industry best practices.

While these measures may afford some protection for computer systems, they may are not as efficient or effective as most organizations now require. For example, while an administrator may be aware that software requires regular updating, this knowledge does not provide the administrator with an idea of the frequency these updates should occur (e.g., days, weeks, months, etc.) in order to provide optimal data protection. Further, the administrator may be aware that not all system users require access to all of the data in a given system; however, the administrator is probably not clear about which users require what types of information. These, and other, inefficiencies are typically associated with current security control applications. The effectiveness of the security implementation is also often woefully inadequate. System administrators often don't understand which employees should be able to access which business assets for which purposes. They often implement controls that allow excessive access to too many internal and external people.

What is needed, therefore, is a way to explicitly tie the expression of security policy with the control measures that implement those policies for specific representations of those assets in a computer system.

### SUMMARY OF THE INVENTION

The shortcomings of the prior art are overcome and additional advantages are provided through the provision of a method for implementing policy-based security control functions. The method includes constructing an organizational domain specifying business assets to be secured and the actors in specific roles requiring access to the business assets. The method also includes constructing a control policy domain including system setting attributes and access control policies for a computer system, the access control policies specifying permissions-based access to specified types of data based upon actor and purpose of use criteria. The method further includes mapping user identifiers to corresponding actors and mapping system artifacts in the computer system or subsystem to business assets defined in the organizational domain to which an access control policy is to be applied. The method also includes applying the access control policies to the system.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which ties the expression of security policies directly to the implementation and enforcement of those policies within a computer system. The mechanisms in this invention will male it much easier and likely that organizations will address security policy and that those policies are accurately implemented, configured, and enforced.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system upon which the security control functions may be implemented in accordance with exemplary embodiments;

FIG. 2 illustrates one example of a flow diagram describing a process for implementing the security control functions in accordance with exemplary embodiments; and

FIG. 3 illustrates one example of a computer screen window of a main menu for implementing the security control functions in accordance with exemplary embodiments.

The detailed description explains the preferred embodiments of the invention, together with advantages and features, by way of example with reference to the drawings.

### DETAILED DESCRIPTION OF THE INVENTION

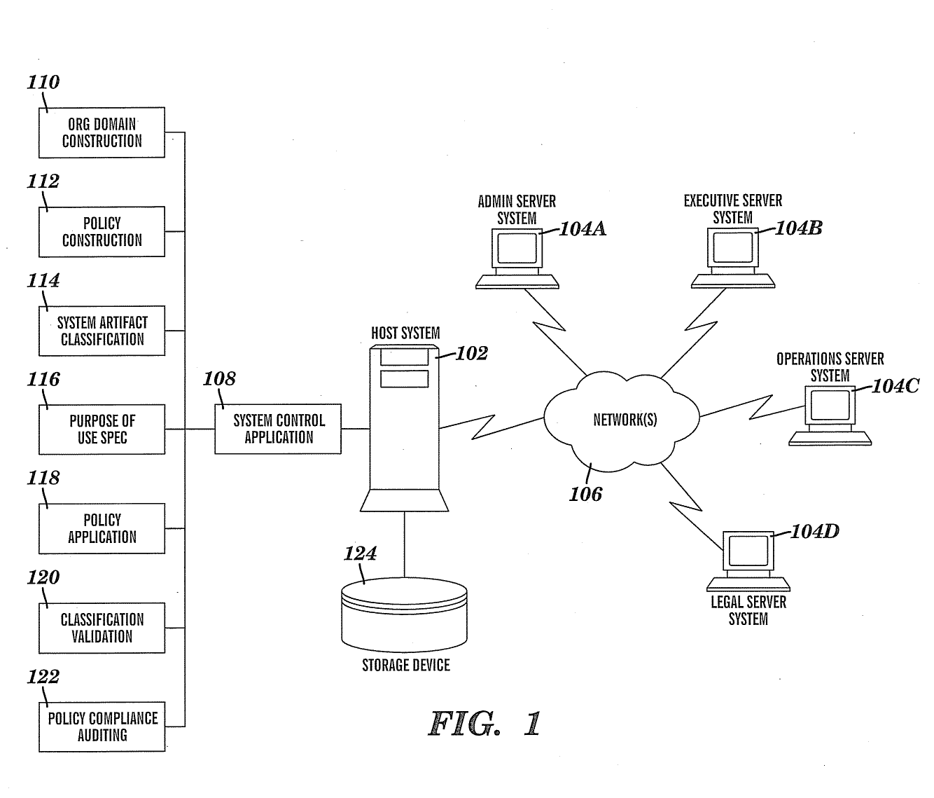

Turning now to the drawings in greater detail, it will be seen that in FIG. 1 there is a system upon which security control functions may be implemented in exemplary embodiments. The security control functions establish security control measures that are compartmentalized by defined policies established for an organization or enterprise so that various risks and exposures of sensitive information and systems are minimized.

The system of FIG. 1 includes a host system 102 in communication with server systems 104A-104D over one or more networks 106. In exemplary embodiments, the host system 102 is operated by an organization or enterprise that implements the security control functions described herein. The host system 102 facilitates and causes the policies established by the enterprise to be accurately enforced with respect to maintaining system security (e.g., data integrity, access control, etc.).

Server systems 104A-104D are administered by individuals who may be employees of the enterprise implementing the host system 102. Each server system 104A-104D may be located within a single facility or may be remotely situated at various geographic locations. Each of server systems 104A-104D may be implemented using a general-purpose computer executing a computer program for carrying out the processes described herein. The server systems 104A-104D may be personal computers (e.g., a lap top, a personal digital assistant) or multi-user server systems. As shown in FIG. 1, server systems 104 include an administrator server system 104A, an executive server system 104B, an operations server system 104C, and a legal server system 104D. Each of these server systems 104 is provided with pre-defined access to data and resources of the system via the security control functions. For example, administrator server system 104A may be permitted to modify user IDs and user groups with respect to access to specified resources of the system. By contrast, an operations server system 104C may be permitted to have read-only access to operations-related data stored within the system (e.g., storage device 124). While only four server systems 104A-104D are shown in the system of FIG. 1, it will be understood that many server systems (and classifications of server systems) may be implemented in order to realize the advantages of the security control functions.

The host system 102 may be implemented using one or more servers operating in response to a computer program stored in a storage medium accessible by the server(s). The host system 102 may operate as a network server (e.g., a web server) to communicate with the server systems 104A-104D. The host system 102 handles sending and receiving information to and from the server systems 104A-104D and can perform associated tasks. The host system 102 executes one or more applications (e.g., security control application 108) to provide the services described herein. It will be understood that a variety of additional applications (e.g., word processing, spreadsheet, Web-based, etc.) may be implemented by the host system 102.

The host system 102 is in communication with a storage device 124. Storage device 124 may be implemented using memory contained in the host system 102 or it may be a separate physical device. In exemplary embodiments, the storage device 124 is in direct communication with the host system 102 (via, e.g., cabling). However, other network implementations may be utilized. For example, storage device 124 may be logically addressable as a consolidated data source across a distributed environment that includes one or more networks 106. Information stored in the storage device 124 may be retrieved and manipulated via the host system 102. Storage device 124 stores a variety of information for use in implementing the security control processes. For example, storage device 124 may store various information elements to be secured (e.g., which comprises sensitive or proprietary information, the disclosure or loss of which would result in harm and/or liability to the enterprise). This information may include database tables, files, directories, libraries, etc., or any information typically associated with the operations of a business or organization. The storage device 124 may also store information created as a result of implementing the security control functions described herein. For example, storage device 124 may store organization domains, policy domains, system settings, etc.

Network(s) 106 may be any type of known network including, but not limited to, a wide area network (WAN), a local area network (LAN), a global network (e.g. Internet), a virtual private network (VPN), and an intranet. The network(s) 106 may be implemented using a wireless network or any kind of physical network implementation known in the art. A server system 104 may be coupled to the host system 102 through multiple networks (e.g., intranet and Internet) so that not all server systems 104 are coupled to the host system 102 through the same network. One or more of the server systems 104 and the host system 102 may be connected to the network 106 in a wireless fashion.

The security control application 108 comprises seven components or modules which facilitate the expression of the policies and related features of the security control processes. These components include organizational domain construction 110, policy domain constriction 112, system artifact classification 114, purpose of data use specifications 116, policy application 118, classification validation 120, and policy compliance auditing 122. Components 110 and 112 enable business asset owners to express security policies in terms of the business assets (rather than the computer system objects that make up those assets) they own or for which they are responsible. Components 114-122 enable computer system administrators to enforce (rather than define and enforce) the policies expressed by the business asset owners more quickly, easily, and accurately.

The domain construction component 110 builds a set of abstract actors, actions, and resources that policies are allowed to use. Policy construction component 112 enables a set of abstract statements about access control, password settings, and system settings. System artifact classification component 114 provides the ability to map system artifacts (e.g., user IDs, files, database tables, etc.) to objects in the organizational domain (e.g., actors and resources of data types). Purpose of data use specification component 116 defines what mechanisms in the system enforce policies that include a specific purpose of use requirement. Policy application component 118 takes a policy along with all the system classification and mapping data and changes the security control settings on a server system to be in compliance with the security policy. Classification validation component 120 determines which system artifacts, if any, have been added to the system since the last application of policy and which are currently unclassified; or system artifacts, if any, that have been removed since the last application of policy; or system artifacts, if any, which have changed in some way that would affect the enforcement of security policy. Policy compliance auditing component 122 verifies that the current security attributes or system settings of the system artifacts are in compliance with the policy. These components are described further herein.

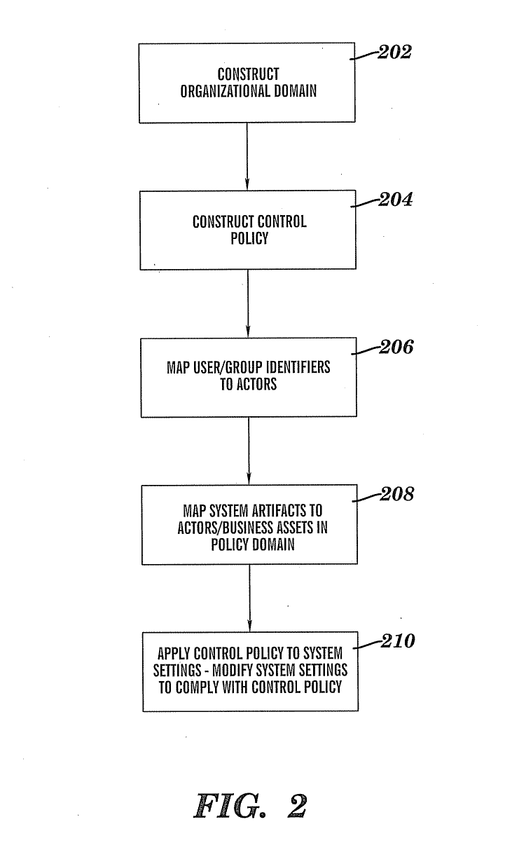

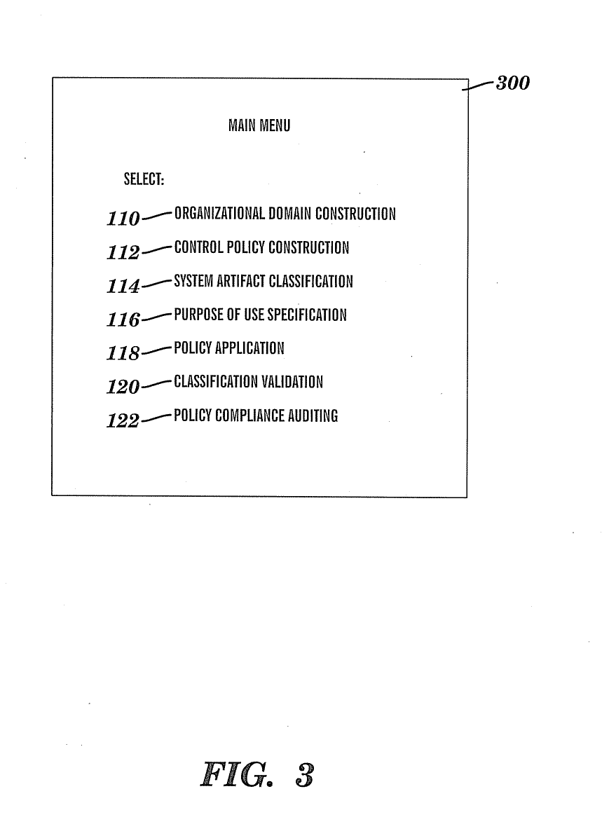

Turning now to FIG. 2 a flow diagram describing a process for implementing the security control functions will now be described in exemplary embodiments. The security control application 108 provides a user interface through which administrators of one or more server systems 104A-104D may cause: 1) the expressed security policies to be enforced on the server system; 2) audit the compliance of a server system to the expressed security policies; and 3) evaluate the accuracy of the data classification for a server system. The components 110-122 may be selected from a main menu provided by the security control application 108 via the user interface. A user interface 300 illustrating a main menu is shown in FIG. 3.

At step 202, an organizational domain is constructed. The construction of the organizational domain is enabled via the domain construction component 110 of the security control application 108. In exemplary embodiments, the domain construction processes may involve all parts of an enterprise and is managed at the highest level. Members of the enterprise provide input regarding the business assets to be secured, the roles of employees within the organization, and the actions people in those roles can take on those business assets. Through this activity, it may be discovered that the organization contains assets related to specific business tasks such as sales, manufacturing, and human resources. Thus, it may also be determined, e.g., that there is an employee role responsible for sending bills to customers, another that determines bonuses for salesmen, and another that seeks to improve the manufacturing process. The enterprise may then construct three organizational domains each of which would contain the security policies for the business assets associated with one of the specific business tasks. Alternatively, the enterprise could choose to create a single organizational domain to contain the security policies for business assets associated with all of the business tasks in the organization. The business assets reflect the abstract notion of a business asset. For example, the information generated and used by the sales department along with the systems and applications which access that information constitute a business asset to be secured. The organizational domain would also contain the actors (or roles), e.g., accountant, payroll provider, and process engineer. Actors represent the various employee roles in an organization. Thus, an employee who dispenses payroll checks may represent an actor in the role of a “payroll provider”.

At step 204, control policies are created via the policy construction component 112 of the security control application 108. An organization-wide policy may be constructed containing several pieces of information. For example, the policy may contain several system setting attributes that must be true for any system in the organization (e.g., a requirement that all passwords have a numeric character). In addition, access control policies are established via the policy construction component 112. Access control policies include a set of statements specifying which actors are permitted to access which business assets and for what purposes. A sample access control policy might include: accountants can access sales data for the purpose of billing. Another sample access control policy might include: payroll providers can read human resources data and sales data for the purposes of conducting payroll activities. These access control policies may be expressed using a variety of techniques. For example, a user may enter a policy in natural language that is parsed and shown to the user in a more structured format using a product, such as IBM's SPARCLE™ or similar technique.

At step 206, user and/or group identifiers (user/group IDs) for users of the system are mapped to actors via the system artifact classification component 114. Each system or subsystem for which a policy is to be applied must have the artifacts of that system classified as (or mapped to) actors or business assets defined in the policy domain. For example, any given system has user IDs. Some of these users may be process engineers, accountants, or payroll providers (i.e., actors). Each actor in the policy domain is associated with corresponding user IDs or groups which represent people or groups of people performing the role of the specified actor. Likewise, the business asset resources from the policy domain should be mapped to files, directories, libraries, tables, and columns, programs, etc., on the system. These mappings are specified at step 208. The classification of computer resource artifacts allows the security control application 108 to apply a general abstract policy to a specific physical computer resources

Some access control statements may specify that a business asset can only be accessed for a specific business purpose. There are several ways of determining purpose. In exemplary embodiments, the data is configured for access only using a specific application. In this component, the application that embodies a purpose for a given resource is specified. This may be done on a business asset level if all of the artifacts that constitute a business asset can be used by one application or it can be configured on a system artifact by system artifact basis. This component can take place independent of any system information if a set of known applications is to be used for a given purpose for a given resource. A simpler embodiment of this phase would be that, for a given system, an executable program is mapped to a purpose of a business asset. These activities may be implemented via the purpose of use specification component 116.

At step 210, the access control policies are applied to the system via the policy application component 118. System settings, such as password length are changed and the access attributes of file system and database objects are set according to policy. Using the above enterprise example, access to tables making up manufacturing data would be denied for any user ID not mapped to the process engineer actor role. Read access would be granted to those user IDs which are process engineers. Requiring that data is used only for a specific purpose may be accomplished by creating a user ID that represents a purpose and using a mechanism like “set user ID” to control access to the data. Other mechanisms may be employed as well.

Before changes are made, a report may be presented to the user about what will be changed. After the changes are made, a report may be presented to the user about what changes were made. Additionally, policy items that could not be enforced may be reported for further evaluation and action.

The classification validation component 120 determines whether all system artifacts have been mapped to actors, roles, or purposes defined in the organizational and policy domains (i.e., mappings established via component 114). Considerable time may have passed between the start of the classification phase and the application of the policy. Things like changes to group membership or the creation of new system artifacts may have occurred. These changes may be reported to the user of the invention who may be prompted for the action that should be taken by the invention. For example, new user identifiers (IDs) may be mapped to actors or the entire classification process may be restarted.

The policy compliance auditing component 122 audits compliance of policy actually enforced on a system with the policies defined in a policy domain. The purpose of this is to ensure that system accurately enforces the domain policies or, if not, the deviations are properly reported. This may involve checking the security attributes of system artifacts, looking for group membership changes, and watching for new artifact creation. This process may also be used if the policy is changed to verify that the system is still in compliance. Thus, these components 120-122 may be re-iterated for ongoing validation and auditing.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing policy-based security control functions, comprising:
constructing an organizational domain specifying business assets to be secured and actors in specific roles which require access to the business assets;
constructing a control policy domain including system setting attributes and access control policies for a computer system, the access control policies specifying permissions-based access to specified types of data based upon actor and purpose of use criteria;
mapping user identifiers to corresponding actors;
mapping system artifacts in the computer system, or a subsystem of the computer system, to business assets defined in the organizational domain to which an access control policy is to be applied; and
applying the access control policies to the computer system.

2. The method of claim 1, wherein the actors include at least one of individual user identifiers and group identifiers mapped to the specific roles.

3. The method of claim 1, wherein each of the business assets is mapped to one or more physical or logical locations that store data or programs.

4. The method of claim 1, further comprising validating that the system artifacts are mapped to the actors and the business assets, the system artifacts including at least one of user identifiers, group identifiers, physical storage locations, and logical storage locations; and
reporting discrepancies to a specified entity.

5. The method of claim 4, further comprising auditing the computer system or subsystem of the computer system for compliance with an expressed access control policy and reporting any discrepancies, the auditing including checking security attributes of the system artifacts, looking for group membership changes, and watching for new artifact creation.

6. A system for implementing policy-based security control functions, comprising:
a host system in communication with at least one server system; and
a security control application executing on the host system, the security control application including components for performing:
constructing an organizational domain specifying business assets to be secured and actors in specific roles which require access to the business assets;
constructing a control policy domain including system setting attributes and access control policies for a computer system, the access control policies specifying permissions-based access to specified types of data based upon actor and purpose of use criteria;
mapping user identifiers to corresponding actors;
mapping system artifacts in the computer system, or a subsystem of the computer system, to business assets defined in the organizational domain to which an access control policy is to be applied; and
applying the access control policies to the computer system

7. The system of claim 6, wherein the actors include at least one of individual user identifiers and group identifiers mapped to the specific roles.

8. The system of claim 6, wherein each of the business assets is mapped to one or more physical or logical locations that store data or programs.

9. The system of claim 6, wherein the security control application further performs:
validating that the system artifacts are mapped to the actors and the business assets, the system artifacts including at least one of: user identifiers, group identifiers, physical storage locations, and logical storage locations; and
reporting discrepancies to a specified entity.

10. The system of claim 9, wherein the security control application further performs:
auditing the computer system or subsystem for compliance with an expressed access control policy and reporting any discrepancies, the auditing including checking security attributes of the system artifacts, looking for group membership changes, and watching for new artifact creation.

11. A computer program product for implementing policy-based security control functions, the computer program product including instructions for implementing a method, comprising:
constructing an organizational domain specifying business assets to be secured and actors in specific roles which require access to the business assets;
constructing a control policy domain including system setting attributes and access control policies for a computer system, the access control policies specifying permissions-based access to specified types of data based upon actor and purpose of use criteria;
mapping user identifiers to corresponding actors;
mapping system artifacts in the computer system, or a subsystem of the computer system, to business assets defined in the organizational domain to which an access control policy is to be applied; and
applying the access control policies to the computer system.

12. The computer program product of claim 11, wherein the actors include at least one of individual user identifiers and group identifiers mapped to the specific roles.

13. The computer program product of claim 11, wherein each of the business assets is mapped to one or more physical or logical locations that store data or programs.

14. The computer program product of claim 11, further comprising instructions for implementing:
validating that the system artifacts are mapped to the actors and the business assets, the system artifacts including at least one of user identifiers, group identifiers, physical storage locations, and logical storage locations; and
reporting discrepancies to a specified entity.

15. The computer program product of claim 14, further comprising instructions for auditing the computer system or subsystem of the computer system for compliance with an expressed access control policy and reporting any discrepancies, the auditing including checking security attributes of the system artifacts, looking for group membership changes, and watching for new artifact creation.
